(19) United States
(12) Patent Application Publication
(10) Pub. No.: US 2024/0349131 A1
(43) Pub. Date: Oct. 17, 2024

(54) METHODS, DEVICES, AND SYSTEMS FOR SUPPORTING L1/L2 BASED INTER-CELL MOBILITY

(71) Applicant: ZTE Corporation, Shenzhen (CN)

(72) Inventors: Yingjun ZHOU, Shenzhen (CN); Yin GAO, Shenzhen (CN); Dapeng LI, Shenzhen (CN); Zijiang MA, Shenzhen (CN)

(73) Assignee: ZTE Corporation, Shenzhen (CN)

(21) Appl. No.: 18/749,891

(22) Filed: Jun. 21, 2024

Related U.S. Application Data
(63) Continuation of application No. PCT/CN2022/110679, filed on Aug. 5, 2022.

(51) Int. Cl. H04W 36/00

(52) U.S. Cl. CPC H04W 36/0061; H04W 36/00835

(57) ABSTRACT

The present disclosure describes methods, system, and devices for configuring supporting a layer 1 or layer 2 signaling (L1/L2) based inter-cell mobility. One method includes supporting, by a first network node, a mobility triggering for a user equipment (UE) from the first network node to a second network node by: sending, by the first network node, a first message for the UE to a third network node, the first message comprising mobility information indicating a list of to-be-switched candidate cells for the UE. Another method includes supporting, by a third network node, a mobility triggering for a UE from a first network node to a second network node by: receiving, by the third network node, a first message for the UE from the first network node, the first message comprising mobility information indicating a list of to-be-switched candidate cells for the UE.

### TECHNICAL FIELD

The present disclosure is directed generally to wireless communications. Particularly, the present disclosure relates to methods, devices, and systems for supporting a layer 1 or layer 2 signaling (L1/L2) based inter-cell mobility.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Mobility is one of the important aspects in the rapid evolution of cellular mobile communication systems. There are many issues/problems associated with changing cells for user equipment (UE) moving from a cell boundary to another cell boundary. The issues/problems may include long latency, more signalling overhead, and/or long interruption time.

The present disclosure describes various embodiments for supporting a layer 1 or layer 2 signaling (L1/L2) based inter-cell mobility, addressing at least one of the issues/problems discussed above. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for supporting a layer 1 or layer 2 signaling (L1/L2) based inter-cell mobility. Various embodiments in the present disclosure may increase the resource utilization efficiency, boost latency performance of the wireless communication, and/or conserve energy consumption of user equipment.

In one embodiment, the present disclosure describes a method for wireless communication. The method includes supporting, by a first network node, a mobility triggering for a user equipment (UE) from the first network node to a second network node by: sending, by the first network node, a first message for the UE to a third network node, the first message comprising mobility information indicating a list of to-be-switched candidate cells for the UE.

In one embodiment, the present disclosure describes a method for wireless communication. The method includes supporting, by a third network node, a mobility triggering for a user equipment (UE) from a first network node to a second network node by: receiving, by the third network node, a first message for the UE from the first network node, the first message comprising mobility information indicating a list of to-be-switched candidate cells for the UE.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows a schematic diagram of a wireless communication system.

FIG. 1B shows a schematic diagram of a base station.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a flow diagram of an exemplary embodiment for wireless communication.

FIG. 6 shows a flow diagram of an exemplary embodiment for wireless communication.

FIG. 7 shows a flow diagram of an exemplary embodiment for wireless communication.

FIG. 8 shows a flow diagram of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various embodiments for supporting a layer 1 or layer 2 signaling (L1/L2) based inter-cell mobility.

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users. Mobility is one of the important aspects in the rapid evolution of cellular mobile communication systems. There are many issues/problems associated with changing cells for user equipment (UE) moving from a cell boundary to another cell boundary. The issues/problems may include long latency, more signalling overhead, and/or long interruption time.

For example, in some implementations, a serving cell change may be triggered by a layer 3 (L3) measurements and may be done by a radio resource control (RRC) signalling triggered reconfiguration with synch for change of primary cell (PCell) and primary secondary cell (PSCell), as well as release and add for secondary cells (SCells) when applicable. These implementation may include complete L2 (and/or L1) resets, resulting in more latency, more signalling overhead, and/or more interruption time than beam switch mobility. In some implementations, during the L1/L2 mobility triggering phase for intra-CU inter-DU scenario, when a source DU determines the candidate cell(s) to be activated/switched to (e.g., according to L1 measurement report), it may be unable to inform CU about the L1/L2 mobility triggering.

Various embodiments in the present disclosure include the procedure and signalling to let source DU inform CU about the L1/L2 mobility triggering in case of DU determined L1/L2 mobility triggering for intra-CU inter-DU scenario. Various embodiments in the present disclosure may achieve low latency, low overhead, and short interruption time, thus, improving the efficiency and/or performance of the wireless communication.

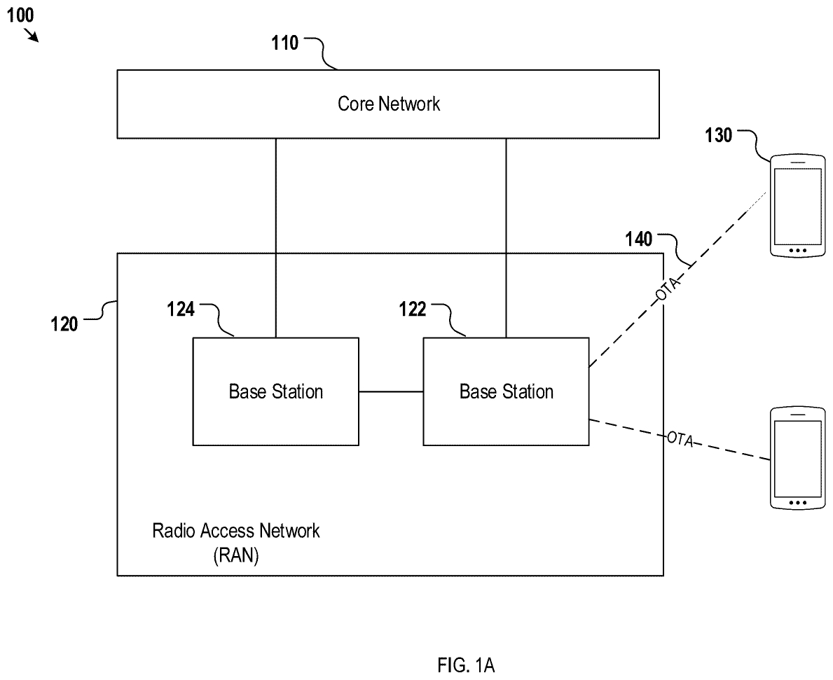

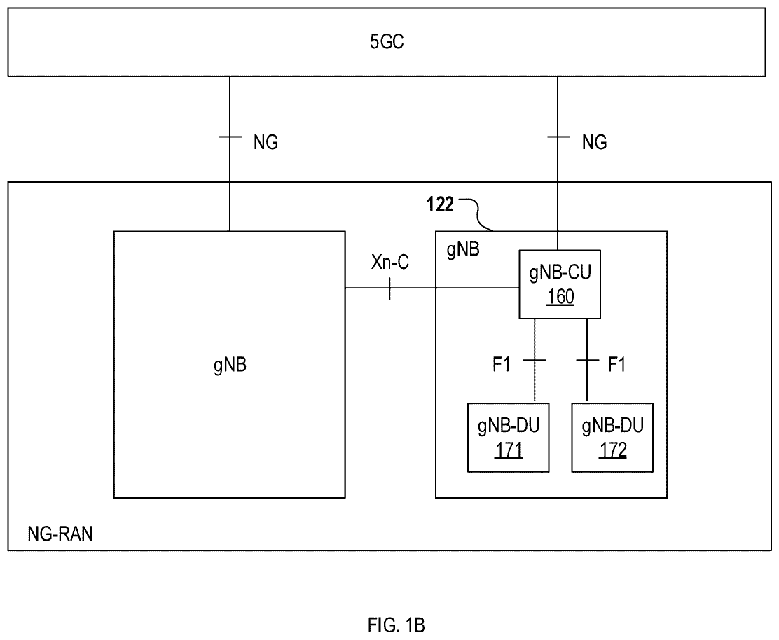

FIG. 1A shows an example cellular wireless communication network 100 (also referred to as wireless communication system) that includes a core network 110, a radio access network (RAN) 120, and one or more user equipment (UE) 130.

The RAN 120 further includes multiple base stations 122 and 124. The base station 122 and one or more user equipment (UE) 130 communicate with one another via Over the Air (OTA) radio communication resources 140. The wireless communication network 100 may be implemented as, as for example, a 2G, 3G, 4G/LTE, 5G, or 6G cellular communication network. Correspondingly, the base stations 122 and 124 may be implemented as a 2G base station, a 3G nodeB, an LTE eNB, or a 5G New Radio (NR) gNB. The UE 130 may be implemented as mobile or fixed communication devices for accessing the wireless communication network 100. The one or more UE 130 may include but is not limited to mobile phones, Internet of Things (IoT) devices, Machine-type communications (MTC) devices, laptop computers, tablets, personal digital assistants, wearable devices, distributed remote sensor devices, roadside assistant equipment, and desktop computers. Alternative to the context of cellular wireless network, the RAN 120 and the principles described below may be implemented as other types of radio access networks, such as Wi-Fi, Bluetooth, ZigBee, and WiMax networks.

In the example wireless communication system 100 of FIG. 1A, the one or more UE 130 may connect with and establish a communication session with the base station 122 via the OTA interface 140. The communication session between the UE 130 and the base station 122 may utilize downlink (DL) and/or uplink (UL) transmission resources. The DL transmission resource carries data from the base station 122 to the UE 130, and the UL transmission resource carries data from the UE 130 to the base station 122. Under certain circumstances, for example when the base station 122 is unavailable or when the UE 130 moves into a coverage of the base station 124, the one or more UE 130 may connect with and establish a communication session with the base station 122.

Referring to FIG. 1B, a base station (e.g., gNB) 122 may have a control-distributed separated structure, which may include a control unit (CU) 160 and one or more distributed unit (DU) 171 and/or 172. The 5GC may communicate with the gNB via a NG interface between them. The gNB and another gNB may communicate via a Xn-C interface. The gNB-CU may communicate with the one or more gNB-DU via a F1 interface.

In some implementations, in the architecture of CU/DU split, The gNB-CU is defined as a logical node hosting RRC, SDAP and PDCP protocols of the gNB or RRC and PDCP protocols of the en-gNB that controls the operation of one or more gNB-DUs. The gNB-DU is defined as a logical node hosting RLC, MAC and PHY layers of the gNB or en-gNB, and its operation is partly controlled by gNB-CU. One gNB-DU supports one or multiple cells. One cell is supported by only one gNB-DU.

In some implementations, to reduce handover interruption time and improve mobility reliability (i.e. mobility robust), a conditional handover (CHO) may be promoted. CHO is defined as a handover that is executed by the UE when execution condition(s) is met. The UE starts evaluating the execution condition(s) upon receiving the CHO configuration, and stops evaluating the execution condition(s) once handover is triggered. The CHO configuration includes the candidate PCell configuration generated by the candidate target node and the corresponding execution condition(s) for candidate cell.

In some implementations, to improve mobility reliability (i.e. mobility robust) in case of SN change or SN addition, a conditional PSCell addition/change (CPAC) may be promoted. Similar to CHO, CPAC is defined as having a configured CPAC execution condition that determines when/whether the corresponding PSCell addition/change command is executed. Upon receiving the CPAC configuration, a UE starts to evaluate the condition and only executes the CPAC command once the condition is met.

In some implementations, to reduce mobility interruption, a dual active protocol stack (DAPS) based handover procedure may be promoted. In the DAPS based handover procedure, the UE keeps simultaneous connection with the source cell and target cell until releasing the source cell after successful random access to the target cell.

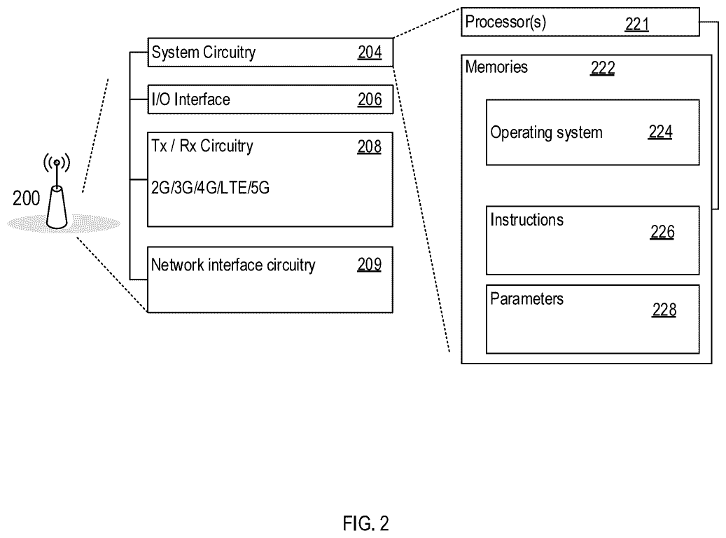

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

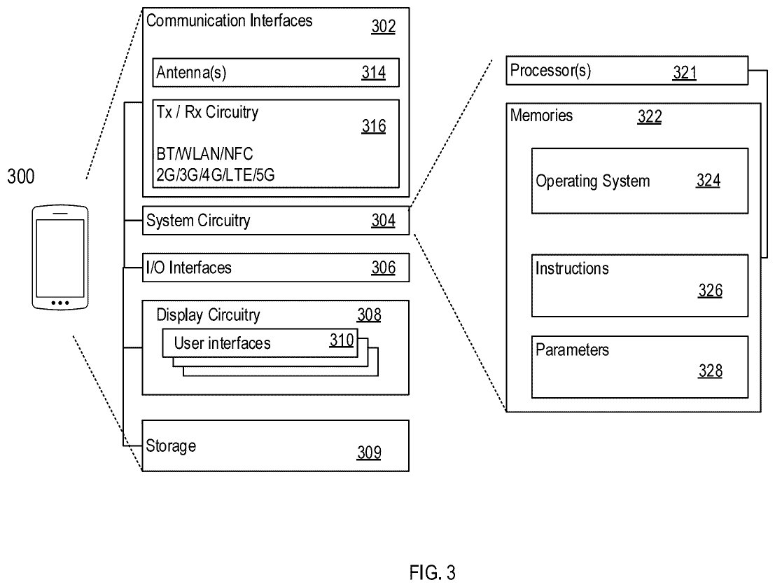

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for supporting a layer 1 or layer 2 signaling (L1/L2) based inter-cell mobility, which may be implemented, partly or totally, on the network base station and/or the user equipment described above in FIGS. 2-3.

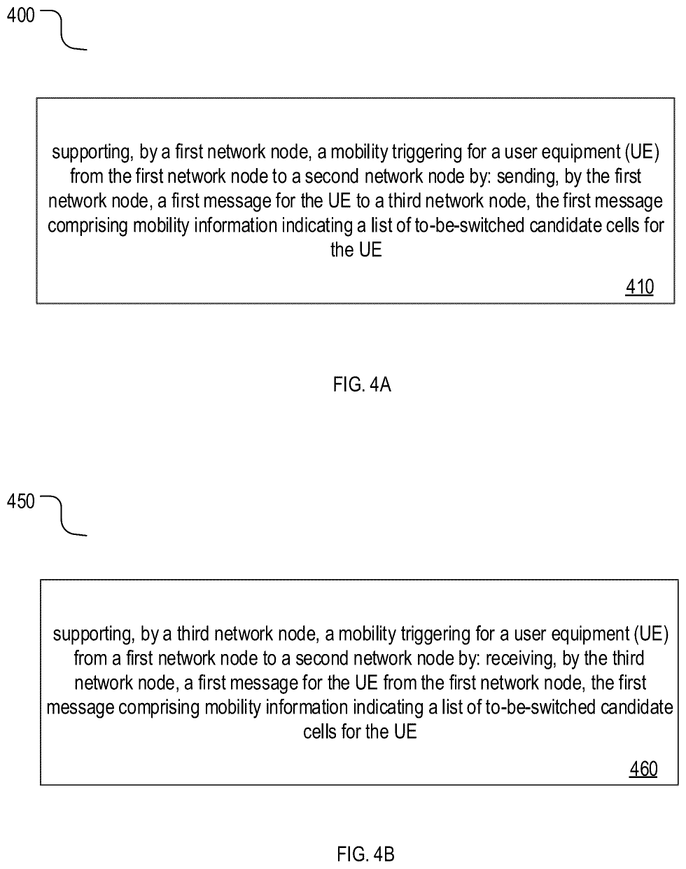

Referring to FIG. 4A, the present disclosure describes various embodiments of a method 400 for wireless communication. The method 400 may include step 410, supporting, by a first network node, a mobility triggering for a user equipment (UE) from the first network node to a second network node by: sending, by the first network node, a first message for the UE to a third network node, the first message comprising mobility information indicating a list of to-be-switched candidate cells for the UE.

Referring to FIG. 4B, the present disclosure describes various embodiments of a method 450 for wireless communication. The method 450 may step 460, supporting, by a third network node, a mobility triggering for a user equipment (UE) from a first network node to a second network node by: receiving, by the third network node, a first message for the UE from the first network node, the first message comprising mobility information indicating a list of to-be-switched candidate cells for the UE.

In various embodiments and/or implementations of the present disclosure, a network node may be referred as a network element.

In some implementations, the first network node comprises a source distributed unit of a base station (gNB-DU); the second network node comprises a candidate gNB-DU; and the third network node comprises a control unit of the base station (gNB-CU).

In some implementations, the mobility triggering comprises a layer 1 or layer 2 signaling based mobility (L1/L2 mobility) triggering; and the mobility triggering belongs to an inter-DU and intra-CU handover for the UE. An inter-DU handover may include situations when the UE moves from one cell or cells in gNB-DU to another cell or cells in another gNB-DU within the same gNB-CU. An intra-DU handover may include situations when the UE moves from one cell or cells to another cell or cells in a same gNB-DU within the same gNB-CU.

In some implementations, the first message belongs to an F1 interface message.

In some implementations, the F1 interface message comprises at least one of the following: a UE context modification required message, or an access success message.

In some implementations, the mobility information comprises a L1/L2 mobility information; and/or the L1/L2 mobility information comprises at least one of the following: a L1/L2 mobility indicator, the list of to-be-switched candidate cells, a new radio (NR) physical cell identifier (PCI), a NR cell global identifier (CGI), or a NR frequency. In some implementations, when the UE has switched to multiple cells, the L1/L2 mobility information may include multiple PCIs, multiple CGIs and multiple frequencies.

In some implementations, the method 400/450 may further include receiving, by the first network node, a measurement report from the UE; determining, by the first network node, the list of to-be-switched candidate cells according to the measurement report; and/or sending, by the first network node, a command to the UE, the command indicating the list of to-be-switched candidate cells.

In some implementations, the measurement report comprises a L1 measurement report; and/or the command comprises a L1/L2 command comprising a list of to-be-switched cell IDs.

In some implementations, in response to receiving the command, the UE begins switching to the list of to-be-switched candidate cells.

In some implementations, the UE begins switching to the list of to-be-switched candidate cells by: beginning a random access procedure with the list of to-be-switched candidate cells.

In some implementations, the first message comprises a downlink data delivery status frame; and/or the first network node receives a first confirmation message from the third network node, wherein, in response to receiving the first message, the third network node sends the first confirmation message to the first network node.

In some implementations, the first message is a UE context modification required message; the first confirmation message is a UE context modification confirm message; and/or the downlink data delivery status frame indicates unsuccessfully transmitted data for the UE.

In some implementations, the first message comprises a downlink data delivery status frame; and/or the first message requires no confirmation message from the third network node.

In some implementations, the first message is an access success message; and/or the downlink data delivery status frame indicates unsuccessfully transmitted data for the UE.

In some implementations, the first network node receives a first confirmation message from the third network node, wherein, in response to receiving the first message, the third network node sends the first confirmation message to the second network node; and/or the first network node sends one of the following to the third network node: a downlink data delivery status frame, or a second message comprising the downlink data delivery status frame.

In some implementations, the first message is a UE context modification required message; the first confirmation message is a UE context modification confirm message; and/or the downlink data delivery status indicates unsuccessfully transmitted data for the UE.

In some implementations, the first message requires no confirmation message from the third network node; and/or the first network node sends one of the following to the third network node: a downlink data delivery status frame, and/or a second message comprising the downlink data delivery status frame.

In some implementations, the first message is an access success message; and/or the downlink data delivery status indicates unsuccessfully transmitted data for the UE.

The present disclosure describes various embodiments with non-limiting exemplary examples for supporting a layer 1 or layer 2 signaling (L1/L2) based inter-cell mobility. For a non-limiting example, a source DU may send the L1/L2 mobility information to the CU to inform the CU about the information for the candidate cell(s) to be activated/switched via the F1 interface message (e.g. UE context modification required message, or access success message, or other message). The L1/L2 mobility information may include one or more of the following: L1/L2 mobility indicator, activated/switched cell list, NR PCI, NR CGI, NR frequency (e.g. NR frequency info IE). In some implementations, the source DU may also sends a downlink data delivery status frame via the same (or another) F1 interface message to inform the CU about the unsuccessfully transmitted downlink data to the UE.

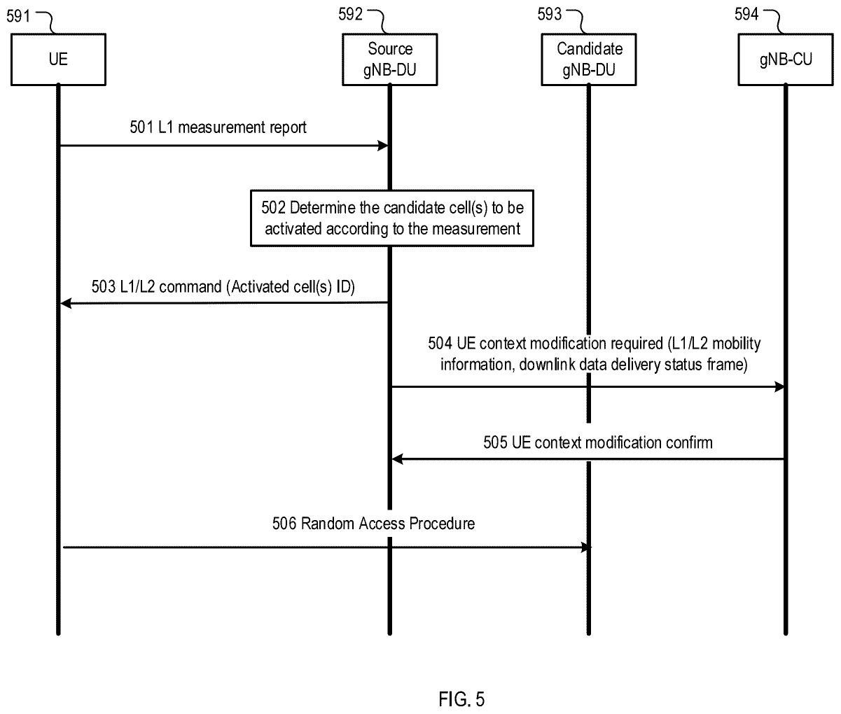

FIG. 5 shows one exemplary embodiment for supporting a L1/L2 based inter-DU inter-cell mobility, wherein a UE 591 may move from a cell operated by a source gNB-DU 592 to another cell operated by a candidate gNB-DU 593. In some implementations, the source gNB-DU and the candidate gNB-DU may communicate with a same gNB-CU 594, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Referring to step 501, the UE sends a L1 measurement report to the source gNB-DU (or referred as “source DU”).

Referring to step 502, the source DU determines the candidate cell(s) to be activated/switched to, e.g. according to L1 measurement report.

Referring to step 503, the source DU sends L1/L2 command to indicate the candidate cell(s) to be activated/switched to the UE.

Referring to step 504, the source DU sends a F1 interface message to the gNB-CU (or referred as “CU”). The F1 interface message may include L1/L2 mobility information and a downlink data delivery status frame. In some implementations, instead of a single F1 interface message as shown in step 504, the source DU may send two F1 interface messages to the gNB-CU: a first F1 interface message may include L1/L2 mobility information; and a second F1 interface message may include a downlink data delivery status frame. In some implementations, the source DU may send the downlink data delivery status frame to the CU directly without including it in a F1 interface message; and/or in response to directly receiving the downlink data delivery status frame, the CU may not need to send a response in response to the received downlink data delivery status frame.

In some implementations, the F1 interface message may be a UE context modification required message. The UE context modification required message may belong to a class 1 message, which may need a response from the message receiver to the message sender.

The L1/L2 mobility information is used to inform the CU about the information for the candidate cell(s) to be activated/switched. The L1/L2 mobility information may include at least one of the following: L1/L2 mobility indicator, activated/switched cell list, NR PCI, NR CGI, NR frequency (e.g. NR frequency info IE). The downlink data delivery status frame is used to inform the CU about the unsuccessfully transmitted downlink data to the UE.

The benefits of the source DU informing the gNB-CU about the L1/L2 mobility information includes that, the CU being aware of DU determined L1/L2 mobility triggering may effectively avoid the conflicts between L1/L2 mobility and traditional mobility, i.e. serving cell change triggered by L3 measurements and done by RRC signalling.

Referring to step 505, in response to receiving the UE context modification required message (as a class 1 message), the CU responds to the source DU with UE context modification confirm message.

Referring to step 506, the UE activates/accesses the target cell, e.g. via random access procedure.

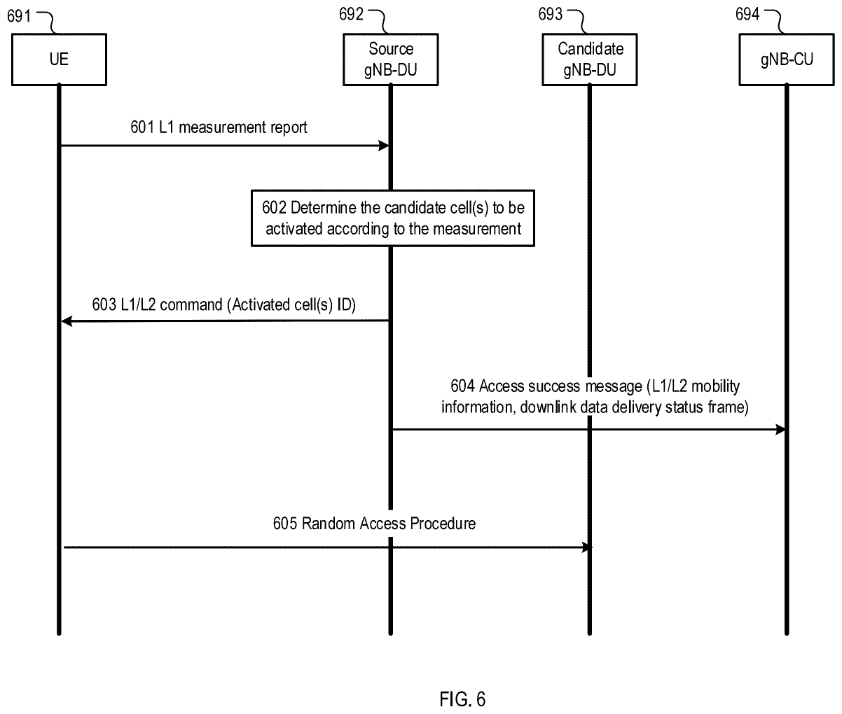

FIG. 6 shows another exemplary embodiment for supporting a L1/L2 based inter-DU inter-cell mobility, wherein a UE 691 may move from a cell operated by a source gNB-DU 692 to another cell operated by a candidate gNB-DU 693. In some implementations, the source gNB-DU and the candidate gNB-DU may communicate with a same gNB-CU 694, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Referring to step 601, the UE sends a L1 measurement report to the source gNB-DU (or referred as “source DU”).

Referring to step 602, the source DU determines the candidate cell(s) to be activated/switched to, e.g. according to L1 measurement report.

Referring to step 603, the source DU sends L1/L2 command to indicate the candidate cell(s) to be activated/switched to the UE.

Referring to step 604, the source DU sends a F1 interface message to the gNB-CU (or referred as “CU”). The F1 interface message may include L1/L2 mobility information and a downlink data delivery status frame. In some implementations, instead of a single F1 interface message as shown in step 604, the source DU may send two F1 interface messages to the gNB-CU: a first F1 interface message may include L1/L2 mobility information; and a second F1 interface message may include a downlink data delivery status frame. In some implementations, the source DU may send the downlink data delivery status frame to the CU directly without including it in a F1 interface message; and/or in response to directly receiving the downlink data delivery status frame, the CU may not need to send a response in response to the received downlink data delivery status frame.

In some implementations, the F1 interface message may be an access success message. The access success message may belong to a class 2 message, which does not need a response from the message receiver to the message sender.

The CU, in response to receiving the access success message (as a class 2 message), does not send any response message to the source DU.

The L1/L2 mobility information is used to inform the CU about the information for the candidate cell(s) to be activated/switched. The L1/L2 mobility related information may include L1/L2 mobility indicator, activated/switched cell list, NR PCI, NR CGI, NR frequency (e.g. NR frequency info IE). The downlink data delivery status frame is used to inform the CU about the unsuccessfully transmitted downlink data to the UE.

Referring to step 605, the UE activates/accesses the target cell, e.g. via random access procedure.

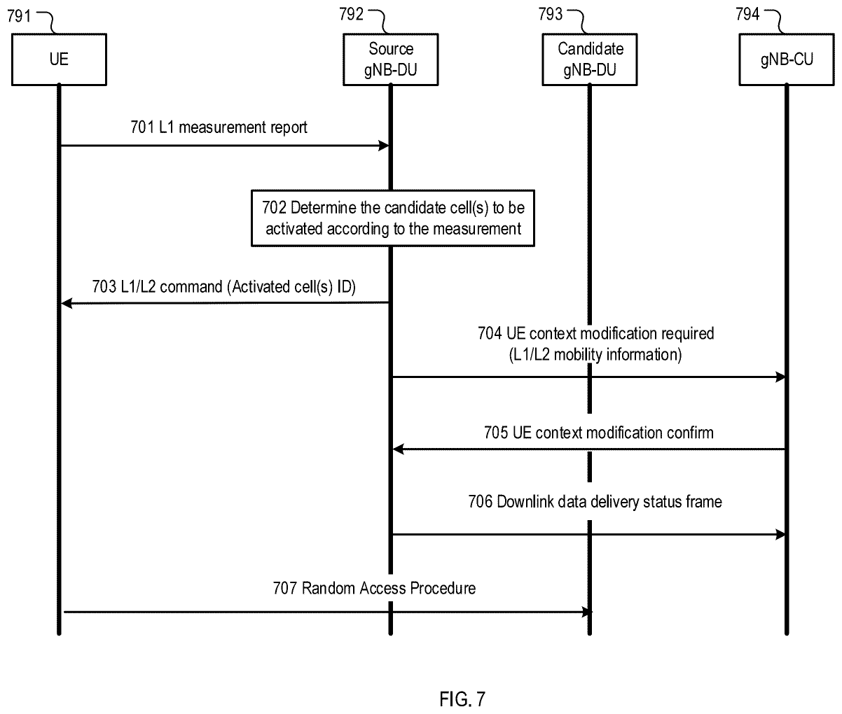

FIG. 7 shows another exemplary embodiment for supporting a L1/L2 based inter-DU inter-cell mobility, wherein a UE 791 may move from a cell operated by a source gNB-DU 792 to another cell operated by a candidate gNB-DU 793. In some implementations, the source gNB-DU and the candidate gNB-DU may communicate with a same gNB-CU 794, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Referring to step 701, the UE sends a L1 measurement report to the source gNB-DU (or referred as “source DU”).

Referring to step 702, the source DU determines the candidate cell(s) to be activated/switched to, e.g. according to L1 measurement report.

Referring to step 703, the source DU sends L1/L2 command to indicate the candidate cell(s) to be activated/switched to the UE.

Referring to step 704, the source DU sends a first F1 interface message to the gNB-CU (or referred as “CU”). The first F1 interface message may include L1/L2 mobility information. In some implementations, the first F1 interface message may be a UE context modification required message. The UE context modification required message may belong to a class 1 message, which may need a response from the message receiver to the message sender. The L1/L2 mobility information is used to inform the CU about the information for the candidate cell(s) to be activated/switched. The L1/L2 mobility information may include at least one of the following: L1/L2 mobility indicator, activated/switched cell list, NR PCI, NR CGI, NR frequency (e.g. NR frequency info IE).

Referring to step 705, in response to receiving the UE context modification required message (as a class 1 message), the CU responds to the source DU by sending a UE context modification confirm message.

Referring to step 706, the source DU sends a second F1 interface message to the gNB-CU (or referred as “CU”). The second F1 interface message may include a downlink data delivery status frame. In some implementations, the second F1 interface message may be an access success message. The access success message may belong to a class 2 message, which does not need a response from the message receiver to the message sender. The downlink data delivery status frame is used to inform the CU about the unsuccessfully transmitted downlink data to the UE. In some implementations, the source DU may send the downlink data delivery status frame to the CU directly without including it in a F1 interface message; and/or in response to directly receiving the downlink data delivery status frame, the CU may not need to send a response in response to the received downlink data delivery status frame.

Referring to step 707, the UE activates/accesses the target cell, e.g. via random access procedure.

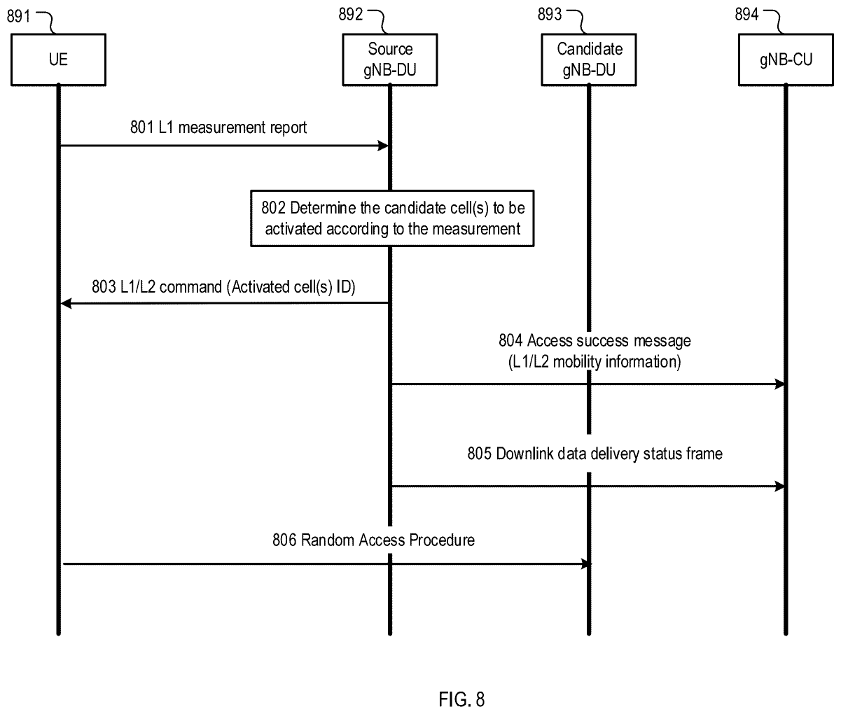

FIG. 8 shows another exemplary embodiment for supporting a L1/L2 based inter-DU inter-cell mobility, wherein a UE 891 may move from a cell operated by a source gNB-DU 892 to another cell operated by a candidate gNB-DU 893. In some implementations, the source gNB-DU and the candidate gNB-DU may communicate with a same gNB-CU 894, which can be referred as intra-CU inter-DU inter-cell mobility. The exemplary embodiment may include a portion or all of the following steps. The following steps are labeled with step numbers, which are used for labeling the steps and do not impose any limitation on the order/sequence of the steps.

Referring to step 801, the UE sends a L1 measurement report to the source gNB-DU (or referred as “source DU”).

Referring to step 802, the source DU determines the candidate cell(s) to be activated/switched to, e.g. according to L1 measurement report.

Referring to step 803, the source DU sends L1/L2 command to indicate the candidate cell(s) to be activated/switched to the UE.

Referring to step 804, the source DU sends a first F1 interface message to the gNB-CU (or referred as “CU”). The first F1 interface message may include L1/L2 mobility information. In some implementations, the first F1 interface message may be an access success message. The access success message may belong to a class 2 message, which does not need a response from the message receiver to the message sender.

The CU, in response to receiving the access success message (as a class 2 message), does not send any response message to the source DU.

The L1/L2 mobility information is used to inform the CU about the information for the candidate cell(s) to be activated/switched. The L1/L2 mobility related information may include L1/L2 mobility indicator, activated/switched cell list, NR PCI, NR CGI, NR frequency (e.g. NR frequency info IE).

Referring to step 805, the source DU sends a second F1 interface message to the gNB-CU (or referred as “CU”). The second F1 interface message may include a downlink data delivery status frame. In some implementations, the first F1 interface message may be an access success message. The downlink data delivery status frame is used to inform the CU about the unsuccessfully transmitted downlink data to the UE. In some implementations, the source DU may send the downlink data delivery status frame to the CU directly without including it in a F1 interface message; and/or in response to directly receiving the downlink data delivery status frame, the CU may not need to send a response in response to the received downlink data delivery status frame.

Referring to step 806, the UE activates/accesses the target cell, e.g. via random access procedure.

The present disclosure describes methods, apparatus, and computer-readable medium for wireless communication. The present disclosure addressed the issues with supporting a L1/L2 based inter-cell mobility. The methods, devices, and computer-readable medium described in the present disclosure may facilitate the performance of wireless communication by supporting a L1/L2 based inter-cell mobility, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
supporting, by a first network node, a mobility triggering for a user equipment (UE) from the first network node to a second network node by:
sending, by the first network node, a first message for the UE to a third network node, the first message comprising mobility information for the UE.

2. (canceled)

3. The method according to claim 1, wherein:
the first network node comprises a source distributed unit of a base station (gNB-DU);
the second network node comprises a candidate gNB-DU; and
the third network node comprises a control unit of the base station (gNB-CU).

4. The method according to claim 1, wherein:
the mobility triggering comprises a layer 1 or layer 2 signaling based mobility (L1/L2 mobility) triggering; and
the mobility triggering belongs to an inter-DU and intra-CU handover for the UE.

5. The method according to claim 1, wherein:
the first message belongs to an F1 interface message.

6. (canceled)

7. The method according to claim 1, wherein:
the mobility information comprises a L1/L2 mobility information; and
the L1/L2 mobility information comprises at least one of the following: a L1/L2 mobility indicator, a list of to-be-switched candidate cells, a new radio (NR) physical cell identifier (PCI), a NR cell global identifier (CGI), or a NR frequency.

8. The method according to claim 1, further comprising:
receiving, by the first network node, a measurement report from the UE;
determining, by the first network node, at least one to-be-switched candidate cell according to the measurement report; and
sending, by the first network node, a command to the UE, the command indicating the at least one to-be-switched candidate cell.

9. (canceled)

10. (canceled)

11. (canceled)

12. The method according to claim 1, wherein:
the first message comprises a downlink data delivery status frame; and
the first network node receives a first confirmation message from the third network node, wherein, in response to receiving the first message, the third network node sends the first confirmation message to the first network node.

13. (canceled)

14. The method according to claim 1, wherein:
the first message comprises a downlink data delivery status frame; and
the first message requires no confirmation message from the third network node.

15. (canceled)

16. The method according to claim 1, wherein:
the first network node receives a first confirmation message from the third network node, wherein, in response to receiving the first message, the third network node sends the first confirmation message to the second network node; and
the first network node sends one of the following to the third network node:
a downlink data delivery status frame, or
a second message comprising the downlink data delivery status frame.

17. (canceled)

18. The method according to claim 1, wherein:
the first message requires no confirmation message from the third network node; and
the first network node sends one of the following to the third network node:
a downlink data delivery status frame, or
a second message comprising the downlink data delivery status frame.

19. (canceled)

20. (canceled)

21. (canceled)

22. A first network node comprising:
a memory storing instructions; and
at least one processor in communication with the memory, wherein, when the at least one processor executes the instructions, the at least one processor is configured to cause the first network node to perform:
supporting a mobility triggering for a user equipment (UE) from the first network node to a second network node by:
sending a first message for the UE to a third network node, the first message comprising mobility information for the UE.

23. The first network node according to claim 22, wherein:
the mobility triggering comprises a layer 1 or layer 2 signaling based mobility (L1/L2 mobility) triggering; and
the mobility triggering belongs to an inter-DU and intra-CU handover for the UE.

24. A method for wireless communication, comprising:
supporting, by a third network node, a mobility triggering for a user equipment (UE) from a first network node to a second network node by:
receiving, by the third network node, a first message for the UE from the first network node, the first message comprising mobility information for the UE.

25. The method according to claim 24, wherein:
the first network node comprises a source distributed unit of a base station (gNB-DU);
the second network node comprises a candidate gNB-DU; and
the third network node comprises a control unit of the base station (gNB-CU).

26. The method according to claim 24, wherein:
the mobility triggering comprises a layer 1 or layer 2 signaling based mobility (L1/L2 mobility) triggering; and
the mobility triggering belongs to an inter-DU and intra-CU handover for the UE.

27. The method according to claim 24, wherein:
the first message belongs to an F1 interface message.

28. The method according to claim 24, wherein:
the mobility information comprises a L1/L2 mobility information; and
the L1/L2 mobility information comprises at least one of the following: a L1/L2 mobility indicator, a list of to-be-switched candidate cells, a new radio (NR) physical cell identifier (PCI), a NR cell global identifier (CGI), or a NR frequency.

29. The method according to claim 24, wherein:
the first message comprises a downlink data delivery status frame; and
the first network node receives a first confirmation message from the third network node, wherein, in response to receiving the first message, the third network node sends the first confirmation message to the first network node.

30. The method according to claim 24, wherein:
the first message comprises a downlink data delivery status frame; and
the first message requires no confirmation message from the third network node.

31. An apparatus comprising:
a memory storing instructions; and
at least one processor in communication with the memory, wherein, when the at least one processor executes the instructions, the at least one processor is configured to cause the apparatus to perform:
supporting a mobility triggering for a user equipment (UE) from a first network node to a second network node by:
receiving a first message for the UE from the first network node, the first message comprising mobility information for the UE.
